(19) United States
(12) Patent Application Publication
(10) Pub. No.: US 2026/0216942 A1
(43) Pub. Date: Jul. 30, 2026

(54) DEVICE FOR MOUNTING AND/OR DISASSEMBLING A SPINNER NOSE, AND APPLICATION TO A PREFORM THERMAL CONDITIONING UNIT

(71) Applicant: SIDEL PARTICIPATIONS, Octeville-sur-Mer (FR)

(72) Inventor: Jocelyn MICHEL, OCTEVILLE-SUR-MER (FR)

(21) Appl. No.: 19/143,798

(22) PCT Filed: Dec. 19, 2023
(86) PCT No.: PCT/EP2023/086689

§ 371 Date: Jun. 26, 2025

(30) Foreign Application Priority Data
Dec. 30, 2022 (FR) FR2214682

(51) Int. Cl. B29C 49/42; B29C 49/36

(52) U.S. Cl. CPC B29C 49/4205; B29C 49/36

(57) ABSTRACT

Provided is a device for locking and/or unlocking at least one spinner nose mounted on a thermal conditioning unit. The device includes a frame, a preform conveying device that has a support and circulates along the frame, and a mandrel that is mounted on the support of the conveying device to rotate about the longitudinal mandrel axis. Each mandrel can include an end that securely attaches the spinner nose to the mandrel. The locking and/or unlocking device also includes a means for preventing each spinner nose from rotating, and a means for locking and/or unlocking the attachment means securing the spinner nose to the mandrel.

### TECHNICAL FIELD OF THE INVENTION

The invention relates to a device for conveying and gripping a tubular preform with rotation of the preform about its main axis, more particularly in a thermal conditioning unit, and to a clamp adapted and intended to be rigidly secured to a robotic arm and to interact with a conveying device. The invention also relates to a method for mounting and/or dismantling at least one spinner nose of a conveying device.

### PRIOR ART

The invention relates to the field of manufacturing of hollow bodies made of thermoplastic material, manufacturing for which a preform is first produced by injection molding. The preform is then formed into a container in a container manufacturing facility.

To this end, the container manufacturing facility comprises a thermal conditioning unit, also referred to as an oven, in which the preform is thermally conditioned, and a blow molding unit for obtaining the final container, in which the preform is formed by blow molding or by stretch blow molding.

The term “hollow body” means a preform of a container, or a final container, or possibly an intermediate container, in other words any type of hollow body comprising a body from which a protruding tubular neck extends.

In the remainder of the document, the term “preform” will preferably be used, without this being limiting.

The preform generally has a tubular cylindrical body which is closed at one of its axial ends and which is extended at its other end by a neck, also tubular.

The neck extends axially from an annular main collar which is arranged at the junction of the neck and the body of the preform, to an annular lip also referred to as a rim, which delimits an axial opening of the neck.

The body of the preform is required to undergo plastic deformation to form the final container during the blow molding operation. In order to carry out this blow molding operation, it is necessary for the body of the preform to be brought to a temperature higher than the glass transition temperature of the material. For this purpose, thermal conditioning of the preform is carried out by circulating the preform inside an oven, using a conveying device following a heating route. The oven comprises heating means which are for example composed of infrared bulbs or laser diodes in front of which the preforms move by virtue of the conveying device. When moving in the oven, the preform is advantageously rotated about its main axis in order to heat it uniformly.

The preforms are usually held on the conveying device by gripping means.

The preform is transferred, or loaded, at the oven inlet by means for transferring the preform from a preform feed device to the conveying device.

The operation of taking hold of a preform using gripping devices is known in French as “vêtissage”, and will be called “loading” herein.

Similarly, at the oven outlet, the operation of unloading the heated preform from the gripping devices is known in French as “dévêtissage”, and will be called “unloading” herein.

Conventionally, the conveyor devices take hold of the preforms on the inside of the neck using gripping means. The gripping means are thus driven by a vertical movement downward along the main axis of the preform relative to the transfer means in order to allow the insertion of the gripping means into the neck. For this purpose, the conveyor devices travel above the transfer means.

By contrast, the preforms are separated from the conveying device by virtue of the bearing of an ejection face of the ejector on the rim of the preform and the upward movement of the gripping means along the main axis of the preform relative to the transfer means in order to allow the separation of the gripping means from the neck.

The path of a preform carried by the transfer means is generally tangent to the path of the conveyor devices at one point or, at best, the two paths are superimposed over a short distance. This area of overlap at one point or over a short distance is referred to below as the “loading area”.

In order for the loading operation to take place, the gripping means must be synchronized with the transfer means so that the gripping means are actuated exactly in line with the loading area. Similarly, for the unloading operation to take place, the gripping means must be synchronized with the transfer means so that the gripping means are actuated exactly in line with the unloading area.

Such gripping means are well known. See, in particular, European patent EP0935572 which describes a device for conveying and gripping preforms.

Said conveying device comprises:
a support with a vertical axis;
a mandrel with an axis mounted pivotably slidingly relative to the support with a vertical axis, said vertical axis being coaxial with the axis of the mandrel;
a spinner mounted on one end of the mandrel, and which includes:
a spinner nose removably attached to one end of the mandrel and capable of taking hold of a preform.

Alternatively, the spinner comprises:
a spinner nose removably attached to one end of the mandrel and capable of taking hold of a preform and
an ejector at least partially surrounding the spinner nose, rigidly secured to the support with a vertical axis by an attachment means and capable of ejecting a preform.

The same facility must be suitable for the manufacture of containers of different models, and in particular of different capacities. A given model of preform may be suitable for several models of container, but not all. The oven must also be able to heat different models of preform.

Preforms are distinguished not only by the shapes (and sizes) of their bodies, but sometimes have necks of different diameters.

Clearly, therefore, it is then necessary to replace each spinner nose with another, of a diameter adapted to the new model of preform to be heated.

The spinner nose is usually attached on the mandrel by means of a bayonet-type mount. This mount typically takes the form of a bayonet socket. This comprises a groove extending parallel to the longitudinal axis of the mandrel, in which a pin rigidly secured to the spinner nose engages. To dismantle the spinner nose, it is necessary to disengage the pin from the socket. However, the operation required to dismantle a set of spinner noses is quite long. To be specific, for a change of format, it is necessary to dismantle all of the spinner noses of the thermal conditioning unit. Therefore, for a thermal conditioning unit having two hundred spinner noses, it takes four hours for an experienced operator to complete this change.

### SUMMARY OF THE INVENTION

The invention proposes, according to a first subject, a device for locking and/or unlocking at least one spinner nose, intended to be mounted on a thermal conditioning unit comprising at least:
a frame;
a preform conveying device comprising a support, the conveying device traveling along the frame along a predetermined path (T);
a mandrel mounted rotatably about its longitudinal axis, on the support of the conveying device, each mandrel comprising at least:
a first end provided with an attachment means rigidly securing the spinner nose to the mandrel, said spinner nose being capable of receiving the plastic preform;
another portion of the mandrel, opposite said first end, rigidly secured to a drive member for rotating said mandrel, the device for locking and/or unlocking according to the invention is characterized in that it further comprises:
a means for blocking each spinner nose in rotation, and
a means for locking and/or unlocking said attachment means rigidly securing the spinner nose to the mandrel in such a way as to lock and/or unlock the spinner nose 64 with respect to the mandrel 60.

According to another aspect of the invention, the attachment means comprises a male part rigidly secured to said spinner nose and a female part rigidly secured to the mandrel, the male part has a thread at one of its ends and the female part comprises a threaded bore complementary to the thread of the male part.

According to another aspect of the invention, said attachment means comprises a female part rigidly secured to the spinner nose and a male part rigidly secured to the mandrel, the male part has a thread at one of its ends, the female part comprises a threaded bore complementary to the thread of the male part.

According to another aspect of the invention, the locking and/or unlocking means is rigidly secured to the frame of the thermal conditioning unit.

According to another aspect of the invention, the blocking means comprises a clamp consisting of two branches, movable relative to one another, each branch being provided at its free end with a jaw capable of gripping the spinner nose to immobilize it in rotation.

According to another aspect of the invention, at least one branch of the clamp is driven by an actuator.

According to another aspect of the invention, said blocking means comprises a cylinder consisting of a body attached to the frame and a piston adapted to be moved to bear on the spinner nose to immobilize it in rotation.

According to another aspect of the invention, the locking and/or unlocking means comprises a second actuator provided with a member for unlocking and/or locking the attachment means intended to interact with the drive member to rotate the mandrel and thus unlock and/or lock the attachment means.

According to another aspect of the invention, the locking and/or unlocking member comprises at least one wheel located in a horizontal plane, comprising at its periphery fingers spaced apart by a certain pitch.

According to another aspect of the invention, the pitch between each finger is defined such that the fingers are inserted between each tooth of said drive member which rotates as one with one of the free ends of the mandrel.

The invention proposes, according to a second subject, a preform thermal conditioning unit.

The preform thermal conditioning unit according to the invention is characterized in that it comprises a device for locking and/or unlocking at least one spinner nose according to any one of the preceding aspects of the invention, rigidly secured to the frame of the preform thermal conditioning unit.

According to another aspect of the invention, at least one first actuator capable of moving said locking and/or unlocking means from a position referred to as the active position, in which the locking and/or unlocking means extends on the path T, to a position referred to as the inactive position, in which the locking and/or unlocking means does not extend on the path T, and vice versa.

The invention proposes, according to a third subject, a method for locking and/or unlocking the spinner nose of a thermal conditioning unit according to any one of the preceding aspects of the invention, comprising at least the following steps:
blocking the spinner nose;
rotating the mandrel to engage and disengage the attachment means rigidly securing the spinner nose to the mandrel.

### BRIEF DESCRIPTION OF THE FIGURES

Further features and advantages of the invention will become apparent upon reading the detailed description which follows, for the understanding of which reference will be made to the appended drawings described briefly below.

FIG. 1 is a schematic general view of a container production facility seen from above;

FIG. 2 is a detailed view of the inset of FIG. 1, showing a preform;

FIG. 3 is an overall view of a conveying device;

FIG. 4 is a schematic view showing a mode of attachment rigidly securing a mandrel and a spinner nose;

FIG. 5 is a sectional view in the locked position of a screw attachment means rigidly securing a mandrel to the spinner nose;

FIG. 6 is a sectional view in the released position of a screw attachment means rigidly securing a mandrel to the spinner nose;

FIG. 7 is an overall view of the device for locking and/or unlocking a spinner nose in the production position;

FIG. 8 is an overall view of the device for locking and/or unlocking a spinner nose in the release position.

### DETAILED DESCRIPTION OF THE INVENTION

In the remainder of the description, elements having an identical structure or similar functions will be designated by the same reference numeral.

The longitudinal, vertical and transverse orientations will be applied with reference to the trihedron (L, V, T) shown in the figures, this not being limiting.

By convention, the longitudinal and transverse directions are determined fixedly relative to the molding devices such that whether an element is in the open or closed position has no bearing on said orientations.

Use will also be made of the terms “front” and “rear” with reference to the longitudinal orientation, and “upper” and “lower” with reference to the vertical orientation and lastly “left” or “right” and “inner” or “outer” with reference to the transverse orientation, this not being limiting.

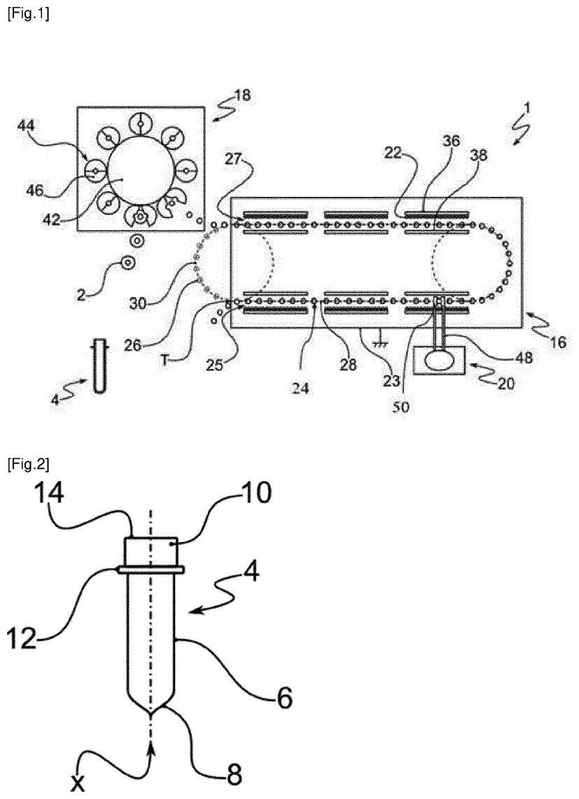

FIG. 1 schematically shows a facility 1 for the mass production of containers 2 made of thermoplastic material from preforms 4.

In the remainder of the description, the preforms 4 and the containers 2 move in the production facility along a circulation route from upstream to downstream. The preforms 4 are moved in a line along a heating route by conveying means which will be described in more detail below.

In this case, the containers 2 are bottles, without this being limiting. The thermoplastic material is in this case, for example, polyethylene terephthalate, hereinafter referred to by its acronym “PET”.

Such a preform 4, with reference to FIG. 2, has a main axis “X” shown vertically in the figure. It has a cylindrical body 6 with a tubular wall closed at one of its axial ends by a bottom 8, and open at its other end by a neck 10, also tubular. The neck 10 is delimited at the bottom by a collar 12 and at the top by an upper end edge referred to as a rim 14.

The neck 10 is generally in its final shape whereas the body 6 of the preform is intended to undergo a relatively significant deformation to form the final container 2 during a forming step.

As shown in FIG. 1, the container manufacturing facility 1 comprises at least one thermal conditioning unit 16, a forming unit 18 and a manipulator 20.

The thermal conditioning unit 16, also referred to as an oven, makes it possible to heat a succession of preforms to a reference temperature. The reference temperature is selected so that the body 6 of each preform at the outlet of the thermal conditioning unit 16 is in a malleable state allowing deformation of the body 6 of the heated preform in order to form the container 2 in the forming unit. The reference temperature is between the glass transition temperature and the crystallization temperature of the plastic material of the preform. In the case of PET, the reference temperature is around 110°for example. The reference temperature value may vary depending on the product with which the container will be filled or depending on the container filling technique. Therefore, the reference temperature is different for hot filling or for a carbonated product for example.

According to the embodiment shown in FIG. 1, the thermal conditioning unit 16 is a tunnel oven, through which the preforms 4 are conveyed so as to be exposed to a plurality of heat radiation sources 22.

For this purpose, the thermal conditioning unit 16 comprises a means for conveying 24 the preforms traveling along a frame 23 through the thermal conditioning unit along a heating route extending between an inlet 25 and an outlet 27 of the thermal conditioning unit defining a path T.

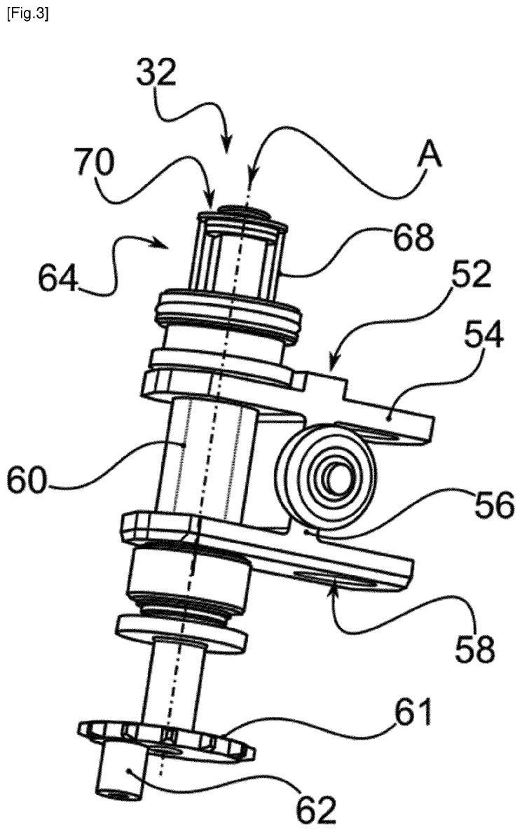

As shown in FIGS. 1 and 3, the conveying means 24 comprises a succession of conveying devices 26, each adapted to hold a preform, and mounted on a chain 28, moving along the heating route, in other words between the inlet and the outlet for preforms in the thermal conditioning unit. The chain runs on wheels 30, at least one of which is motorized.

In another embodiment that has not been shown, the conveying means comprises for example a succession of gripping devices, each being adapted to hold a preform, and mounted on a linear motor shuttle traveling on a magnetic closed loop. The movement of each of these shuttles is controlled independently of one another by a control unit (not shown in the figures). Each conveying device 26 is, for example, adapted to receive a preform by fitting the neck onto a spinner 32. Each spinner 32 is, for example, rotatable relative to the chain about an axis A of rotation coinciding with the main axis X of a preform when the latter is held by the spinner.

The oven also comprises a heating cavity which comprises two side walls 36 facing one another, at least one of these walls being the wall which supports several radiation sources 22, arranged one above the other and one beside the other facing the preforms.

In other words, the thermal conditioning unit 16 comprises a plurality of radiation sources 22 distributed along the route of the path T and at a height corresponding substantially to the height of the preforms such that the entire height of the body of each preform is exposed to the radiation sources over the route of the preform in the thermal conditioning unit. By rotating the preforms about their main axis X, the spinners 32 make it possible to uniformly expose the entire body 6 of the preforms to the radiation sources 22. In this particular embodiment, the radiation sources 22 are distributed on one side only of this route, and a reflective wall 38 is arranged on the other side of the heating route to reflect heat back onto the preforms.

In another embodiment that has not been shown, the radiation sources 22 may be distributed on either side of the heating route without thereby departing from the scope of the invention.

Note also that the radiation sources 22 are arranged, where appropriate, so as not to subject the neck 10 to the heat emitted by the radiation sources. To be specific, as stated above, only the body 6 of the preform 4 is heated to produce the container. Therefore, the neck 10 must not be deformed during forming and must not be heated. To avoid heating the neck 10, the oven may comprise a ventilation device positioned in line with the necks to discharge the heat likely to be absorbed by the necks.

Each radiation source 22 is formed by an incandescent bulb emitting infrared radiation.

In another embodiment, each radiation source is a laser diode emitting infrared radiation.

In other words, each radiation source 22 is a laser (e.g. laser diodes) emitting in the infrared and laid out in a juxtaposed and/or superposed arrangement to form one or more matrices.

In another embodiment, each radiation source 22 is a microwave generator.

Obviously, the radiation sources 22 may consist of any radiation source well known to those skilled in the art, or a combination of these radiation sources, without departing from the scope of the invention.

Then, once the preform 4 has been thermally conditioned in the thermal conditioning unit 16, it is transferred to the forming unit 18 to be formed therein.

The forming unit 18 for forming containers 2 from preforms 4 is made up of a forming wheel 42 rotating a plurality of forming stations 44 from an inlet to an outlet, in which a succession of containers are formed from the preforms, and then extracted, as shown in FIG. 1. The axis of rotation of the forming wheel is, for example, substantially parallel to the main axis X of the preforms when they are conveyed by the forming wheel.

Each blow molding station 44 comprises a mold 46 forming a molding cavity having the shape of the container to be formed and arranged to receive a preform such that the body of the preform extends inside the molding cavity.

The container manufacturing facility 1 further comprises a manipulator 20 provided with a robotic arm 48 equipped at one of its ends with a clamp 50 for dismantling spinners 32. The robotic arm and clamp assembly is movable at least partially in line with the oven, in such a way 1 as to dismantle the spinners 32.

As shown in FIG. 3, the conveying device 26 comprises a support 52, also referred to as a link in the figure, which is integrated in a chain which includes many such links.

In this embodiment, the link, preferably made of metal (e.g. steel), comprises two superimposed branches 54, which project laterally from a core 56. The branches are pierced with coaxial holes 58 which together define a main axis.

The conveying device 26 further comprises:
a mandrel 60 (shown in dotted lines in FIG. 3) with an axis of revolution mounted in the holes 58 of the link via a connection pivotably slidingly relative to the link. Thus, the main axis of the holes and the axis of revolution of the mandrel 60 are coaxial;
a drive member 61 that rotates as one with one of the free ends of the mandrel 60. In this embodiment, the drive member 61 is a pinion which is advantageously formed on an end piece in the form of a reel, force-fitted onto the mandrel 60;
a cam follower 62, in this case a roller, rigidly secured to the drive member 61, said cam follower being off-center relative to the longitudinal axis of the mandrel 60 so as to angularly pre-orient each mandrel 60. Alternatively, the cam follower 62 may be a finger;
a spinner 32 mounted on the other end of the mandrel 60 and comprising at least:
a spinner nose 64 which is removably attached to the mandrel 60, in this case by means of an attachment means which will be described below. The spinner nose 64 is intended to receive the neck of the preform;
an ejector 68 rigidly secured to the support 52. This ejector 68 has a substantially cylindrical shape and comprises at one of its ends at least one face 70 referred to as a preform ejection face.

The mandrel 60 and the spinner nose 64 extend coaxially with the ejector such that the free end of the spinner nose 64 projects from the ejector.

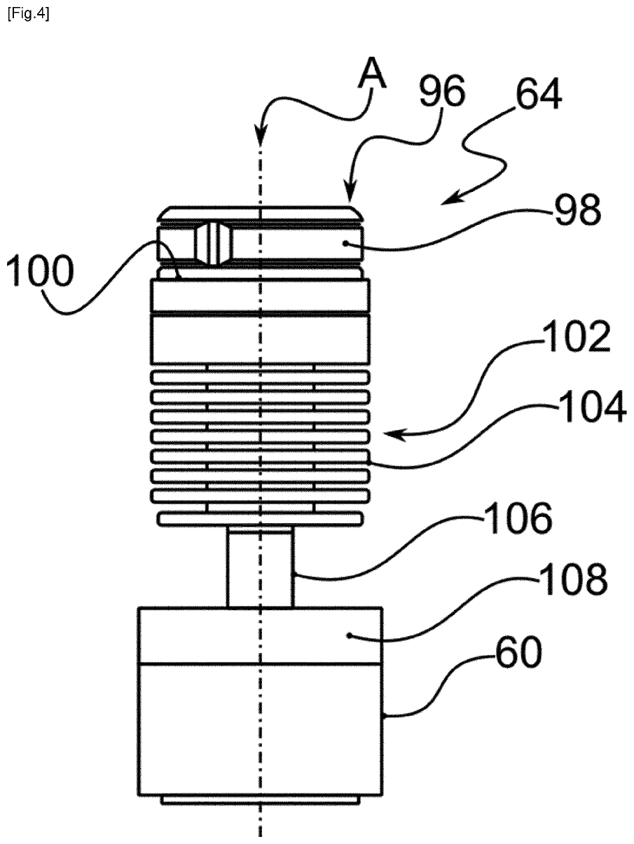

As shown in FIG. 4, the spinner nose 64 comprises a cylindrical head 96 with a vertical axis “A”, the outside diameter of which is slightly smaller than the inside diameter of the neck 10 such that there is a radial sliding clearance between the head and the neck 10 when the head is fitted in the neck 10.

The head 96 comprises rings 98 which are in the form of annular sectors. Each ring 98 is received such that it can slide radially in a radial housing of the head 96 between:
a position retracted toward the axis “A” of the head 96 allowing vertical sliding of the spinner relative to the neck 10 of the preform 4;
a radial expansion position in which they are adapted to be pressed against the inner cylindrical face of the neck 10 to hold the preform 4 in place by friction.

The rings 98 are elastically urged toward their expansion position by means of an elastic annulus which is interposed radially between the bottom of the housing made in the head 96 and the ring 98.

The head 96 is delimited vertically toward the bottom by a segment of larger diameter delimiting an annular shoulder face 100 which faces upwards and which forms a positioning face against which the rim 14 is received in vertical abutment when the head 96 is fitted in the neck 10.

A radiator 102 is arranged under the head 96 and comprises fins 104 which have a generally cylindrical shape with a main vertical axis A, coaxial with the axis A of the head 96, and a diameter which is equivalent to the diameter of the segment with a larger diameter than the head 96.

A shaft 106 is attached at one of its ends to the radiator 102 and head 96 assembly, while the other end of the shaft 106 is removably attached to the mandrel 60, in this case by means of an attachment means 108 which will be described below.

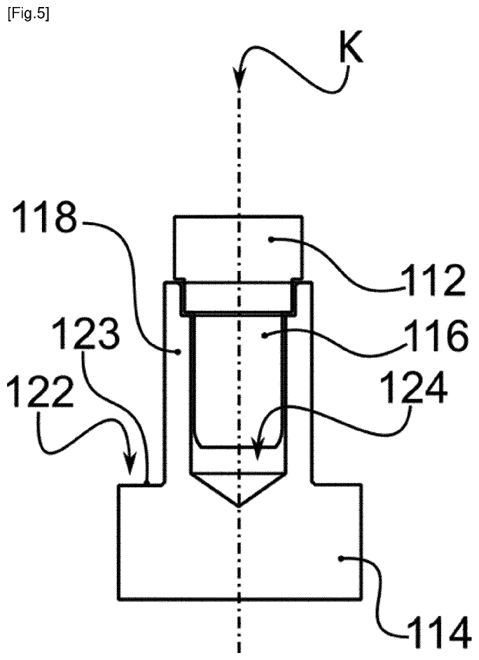

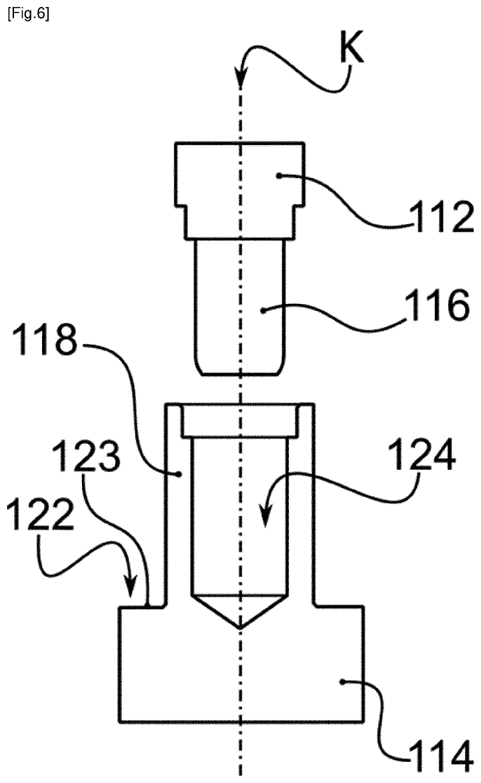

FIGS. 5 and 6 show the screw attachment means 108 for rigidly securing the mandrel 60 to the spinner nose 64. FIG. 5 depicts the attachment means 108 in a locking position and FIG. 6 depicts the attachment means 108 in a release position.

The attachment means 108 comprises a male part 112 rigidly secured to the spinner nose or the mandrel and a female part 114 rigidly secured to the mandrel or the spinner nose.

The male part 112 has a cylindrical shape with a thread 116 at one of its free ends adapted to be inserted in the female part 114.

The female part 114 comprises a peripheral cage 118.

The peripheral cage 118 has a cylindrical shape of axis K, bored at its center, and at one of its ends the peripheral cage 118 extends radially so as to define a shoulder 122 defining a surface 123 referred to as the “upper” surface.

The peripheral cage 118 comprises on its inner wall a threaded bore 124 complementary to the thread 116 of the male part 112.

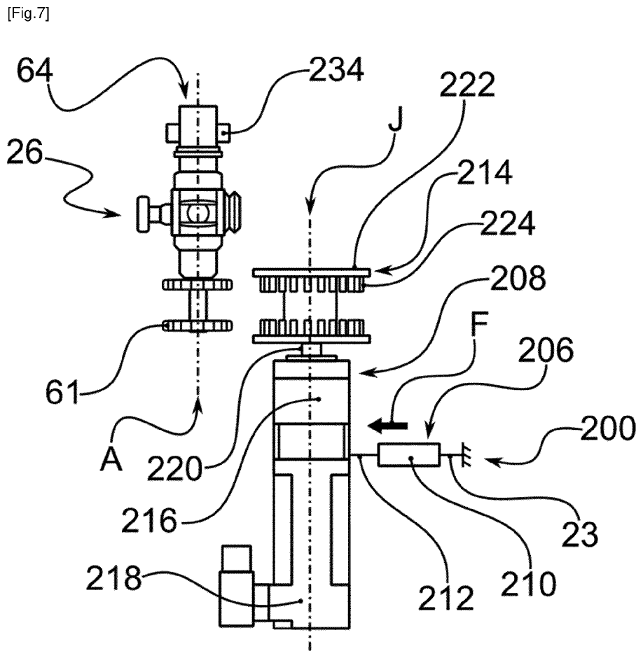

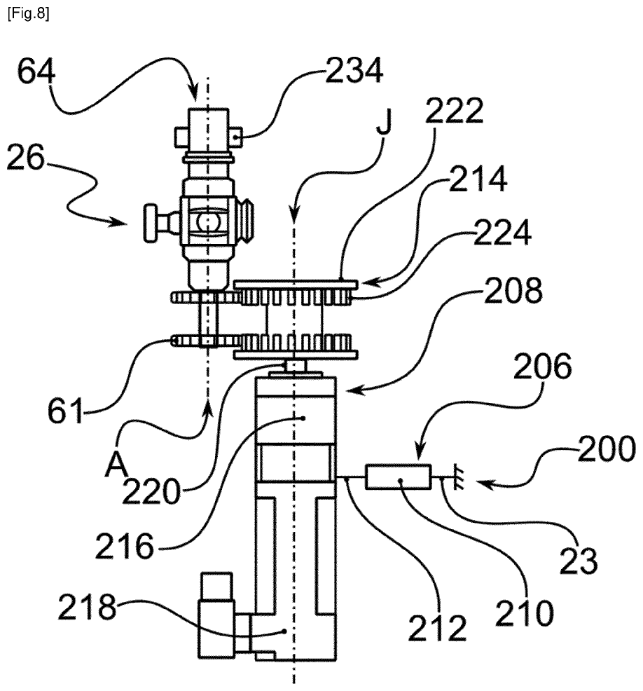

FIGS. 7 and 8 depict an overall view of a device for locking and/or unlocking 200 at least one spinner nose equipping a conveying device 26 positioned on the heating route of the thermal conditioning unit 16, in other words on the wheels 30 or on the side walls 36.

The locking and/or unlocking device 200 is rigidly secured to the frame 23 of the thermal conditioning unit.

In the embodiment shown in FIGS. 7 and 8, the locking and/or unlocking device 200 comprises a first positioning actuator 206 and a locking means 208.

The first actuator 206 is a hydraulic or pneumatic cylinder or any other actuator capable of moving the locking means 208 in a horizontal direction.

The cylinder 206 is formed of a body 210 attached to the frame 23 and a piston 212 movable in translation in the horizontal direction indicated by the arrow F and rigidly secured to the locking means.

The locking means 208 comprises a locking and/or unlocking member 214 rigidly secured to a second actuator 216 mounted such that it is capable of rotating the attachment means 108 from its locking position to its release position.

The second actuator 216 is a motor capable of rotating the locking and/or unlocking member 214 in a vertical direction of axis J.

The motor 216 is formed of a body 218 rigidly secured to the piston 212 of the cylinder constituting the first actuator 206, and a shaft 220 to which the locking and/or unlocking member 214 is rigidly secured to set it in rotation.

The locking and/or unlocking member 214 is positioned in line with the drive member 61 of the conveying device 26 to set it in rotation.

The locking and/or unlocking member 214 is formed of at least one wheel 222 located in a horizontal plane, comprising at its periphery fingers 224 spaced apart by a certain pitch.

In the case where the drive member 61 consists of a pinion, the pitch between each finger 224 is defined such that the fingers are inserted between each tooth of the pinion.

FIGS. 7 and 8 depict the kinematics of the device for locking and/or unlocking 200 at least one spinner nose 64 relative to the conveying device 26.

FIG. 7 depicts an overall view of a device for locking and/or unlocking 200 at least one spinner nose 64 in a production position.

The production position means that the locking and/or unlocking 200 device is not being used and therefore the container production facility is able to produce containers.

The first actuator 206 is retracted and the second actuator 216 is not being rotated.

FIG. 8 depicts an overall view of a device for locking and/or unlocking 200 at least one spinner nose 64 placed in the release position.

The release position means that the locking and/or unlocking 200 device is positioned to carry out the operation of releasing the attachment means 108, in other words the second actuator 216 rotates the locking and/or unlocking member 214 relative to the axis J. Consequently, the locking and/or unlocking member 214 rotates the drive member 61 which was previously blocked by a blocking means 234. Thus, the rotation of the locking and/or unlocking member 214 causes the rotation of the drive member 61 and consequently the rotation of the mandrel 60 which separates the mandrel from the spinner nose 64, in other words the male part 112 from the female part 114 constituting the attachment means 108.

The locking and/or unlocking device 200 also comprises a blocking means 234 rigidly secured to the frame 23 of the thermal conditioning unit 16, or outside the thermal conditioning unit as shown in FIG. 1 by the robotic arm 48.

The blocking means 234 comprises a clamp 50 consisting of two branches, movable relative to one another, each branch being provided at its free end with a jaw capable of gripping the spinner nose 64 to immobilize it in rotation.

This clamp 50 is mounted on the robotic arm 48, as shown in FIG. 1.

Alternatively, the blocking means 234 comprises a cylinder consisting of a body attached to the frame 23 and a piston adapted to be moved to bear on the spinner nose 64 to hold it in place.

This embodiment is not shown in the figures.

The kinematics of the locking and/or unlocking device 200 is controlled by a control unit of the container production facility (not shown).

The control unit controls the torque generated by the second actuator 216 to ensure that locking and/or unlocking are performed correctly.

1. A device for locking and/or unlocking at least one spinner nose, the device configured to be mounted on a thermal conditioning unit and comprising at least:
a frame;
a preform conveying device comprising a support, said conveying device traveling along the frame along a predetermined path;
a mandrel mounted rotatably about a longitudinal axis, on the support of the conveying device,
each mandrel comprising at least:
a first end provided with an attachment means rigidly securing the spinner nose to the mandrel, said spinner nose being capable of receiving a plastic preform;
another portion of the mandrel, opposite said first end, rigidly secured to a drive member for rotating said mandrel,
wherein the locking and/or unlocking device for further comprises:
a means for blocking each spinner nose in rotation; and
a means for locking and/or unlocking said attachment means rigidly securing the spinner nose to the mandrel to lock and/or unlock the spinner nose with respect to the mandrel.

2. The device for locking and/or unlocking at least one spinner nose as claimed in claim 1, wherein said attachment means comprises a male part rigidly secured to said spinner nose and a female part rigidly secured to said mandrel, said male part having a thread at one of its ends and said female part comprising a threaded bore complementary to the thread of the male part.

3. The device for locking and/or unlocking at least one spinner nose as claimed in claim 1, wherein said attachment means comprises a female part rigidly secured to said spinner nose and a male part rigidly secured to said mandrel, said male part having a thread at one of its ends, said female part comprising a threaded bore complementary to the thread of the male part.

4. The device for locking and/or unlocking at least one spinner nose as claimed in claim 1, wherein said locking and/or unlocking means is rigidly secured to said frame of the thermal conditioning unit.

5. The device for locking and/or unlocking at least one spinner nose as claimed in claim 1, wherein said blocking means comprises a clamp consisting of two branches, movable relative to one another, each branch being provided at a free end with a jaw capable of gripping the spinner nose to immobilize it in rotation.

6. The device for locking and/or unlocking at least one spinner nose as claimed in claim 5, wherein the clamp is mounted on a robotic arm.

7. The device for locking and/or unlocking at least one spinner nose as claimed in 5, wherein at least one branch of the clamp is driven by an actuator.

8. The device for locking and/or unlocking at least one spinner nose as claimed in claim 1, wherein said blocking means comprises a cylinder consisting of a body attached to the frame and a piston adapted to be moved to bear on the spinner nose to immobilize it in rotation.

9. The device for locking and/or unlocking at least one spinner nose as claimed in claim 7, wherein the locking and/or unlocking means comprises a second actuator provided with a member for unlocking and/or locking said attachment means configured to interact with the drive member to rotate said mandrel and thus unlock and/or lock the attachment means.

10. The device for locking and/or unlocking at least one spinner nose as claimed in claim 9, wherein the locking and/or unlocking member comprises at least one wheel located in a horizontal plane, the wheel comprising fingers at a periphery the fingers spaced apart by a certain pitch.

11. The device for locking and/or unlocking at least one spinner nose as claimed in claim 10, wherein said pitch between each finger is defined such that the fingers are inserted between each tooth of said drive member which rotates as one with one of the free ends of the mandrel.

12. A preform thermal conditioning unit comprising a device for locking and/or unlocking at least one spinner nose,
wherein the device is rigidly secured to a frame of said preform thermal conditioning unit,
the device comprising:
a frame;
a preform conveying device comprising a support, said conveying device traveling along the frame along a predetermined path;
a mandrel mounted rotatably about a longitudinal axis, on the support of the conveying device, the mandrel comprising a spinner nose;
a means for blocking each spinner nose in rotation; and
a means for locking and/or unlocking said attachment means rigidly securing the spinner nose to the mandrel to lock and/or unlock the spinner nose with respect to the mandrel.

13. The thermal conditioning unit as claimed claim 12, further comprising at least one first actuator configured to move said locking and/or unlocking means from an active position, in which said locking and/or unlocking means extends on the path T, to an inactive position, in which said locking and/or unlocking means does not extend on the path T, and vice versa.

14. A method for locking and/or unlocking the spinner nose of a thermal conditioning unit, the thermal conditioning unit comprising a device for locking and/or unlocking at least one spinner nose, wherein the device is rigidly secured to a frame of said thermal conditioning unit, the method comprising at least the following steps:
blocking the spinner nose; and
rotating the mandrel to engage and disengage said attachment means rigidly securing the spinner nose to the mandrel.
